(19) United States
(12) Patent Application Publication
(10) Pub. No.: US 2014/0195451 A1
(43) Pub. Date: Jul. 10, 2014

(54) UNMANNED SYSTEM FOR ACCEPTING MAIL AND METHOD THEREOF

(71) Applicant: Electronics and Telecommunications Research Institute, Daejeon (KR)

(72) Inventors: Jae Gwan SONG, Daejeon (KR); Young Won KIM, Daejeon (KR); Ji Young CHOI, Daejeon (KR)

(21) Appl. No.: 13/944,166

(22) Filed: Jul. 17, 2013

(30) Foreign Application Priority Data
Jan. 9, 2013 (KR) 10-2013-0002387

(51) Int. Cl. G06Q 10/08

(52) U.S. Cl. CPC G06Q 10/083
USPC 705/330

(57) ABSTRACT

An unmanned system for accepting mail and a method thereof are provided. The unmanned system for accepting mail includes: a weight and size measuring unit measuring, when mail is input by a user through a predetermined input unit, a weight of the mail by moving the input mail to a predetermined position and a size of the mail by using a plurality of sensors which is previously provided at the predetermined position; a delivery charge calculating unit calculating a delivery charge of the mail based on a delivery type selected by the user, and the measured weight and size of the mail; and a mail loading unit assigning the accepted mail to a predetermined loading space in accordance with the delivery type and the size of the mail when the mail is accepted and loading the accepted mail in the assigned loading space.

### CROSS-REFERENCE TO RELATED APPLICATIONS

This application claims priority to and the benefit of Korean Patent Application No. 10-2013-0002387 filed in the Korean Intellectual Property Office on Jan. 9, 2013, the entire contents of which are incorporated herein by reference.

### TECHNICAL FIELD

The present, invention relates to unmanned mail accepting, and more particularly, to a system for accepting unmanned mail and a method thereof that can allow a user to send his/her own mail at his/her free time and can efficiently perform a collection task by loading accepted mail by determining a loading position depending on a type, a weight, a size, and the like of the accepted mail.

### BACKGROUND ART

In recent years, importance of distribution has increased with the development of an industrial society and in particular, a delivery of the distribution has increased due to an increase in telemarketing by a cable TV, and the like and a result of electronic commerce through the Internet with the development of the Internet. Examples of a representative organization that takes charge of the distribution include the post office or a logistics service company.

In general, a mailing client brings mail and visits the post office to send the mail through a counter in order to send the mail. However, sending the mail within business hours of the post office may restrict privacy of individuals in participation of women resources in economic activities and various social activities transcending time. As a result, expansion and spread of an unmanned system for the sake of a client has great implications in terms of financial and administrative processing.

Similarly, means that can accept the mail without being interrupted by time while protecting privacy of individuals has increased even in the post office.

In the existing mail accepting, when a client submits his/her mail to a staff of the counter in the post office, the counter staff accepts the mail through processes such as determination of a standard of the mail, measurement of a quantity and a weight of the mail, charge calculation, receipt of charge and receipt issuing, and the like.

In general, the task of the post office of accepting the mail has limitations in that, the post office is closed after the business hours, clients who want to send the mail frequently wait in line for a predetermined time at a specific, time, and further, the client should send the mail within the business hours of the post office.

Accordingly, the necessity of a system that can accept the mail in a free time zone has come to the fore.

### SUMMARY OF THE INVENTION

The present invention has been made in an effort to provide an unmanned system for accepting mail and a method thereof that can allow a user to sand his/her own mail at his/her free time and can easily collect the mail by loading accepted mail or determining a loading position depending on a type, a weight, a size, and the like of the accepted mail.

An exemplary embodiment of the present invention provides an unmanned system for accepting mail including: a weight and size measuring unit measuring, when mail is input by a user through a predetermined input unit, a weight of the mail by moving the input mail to a predetermined position and a size of the mail by using a plurality of sensors which is previously provided at the predetermined position; a delivery charge calculating unit calculating a delivery charge of the mail based on a delivery type selected by the user, and the measured weight and size of the mail; and a mail loading unit, assigning the accepted mail to a predetermined loading space in accordance with the delivery type and the size of the mail when the mail is accepted and loading the accepted mail in the assigned loading space.

The weight and size measuring unit may include a plurality of sensors disposed at a predetermined interval in an X-axis direction, a Y-axis direction, and a Z-axis direction of the predetermined position, and measure the size of the input mail by using sensors sensing the input mail among the plurality of sensors.

The weight and size measuring unit may include switches disposed on at least two lateral surfaces of the predetermined position, and measure the size of the input mail when a first switch disposed on a first lateral surface and a second switch disposed on a second lateral surface contact the input mail.

The system may further include a mail management server calculating and managing the sizes and the number of conveyance containers and the scale of a vehicle that collect the loaded mail, based on information on the mail loaded in the mail loading unit.

The system may further include: an image acquiring unit acquiring an image of the input mail; and a label generating and attaching unit recognizing a character included in the acquired image, generating information to be printed on a barcode label basset on a character recognition result, and attaching the generated barcode label, to the input mail.

The system may further include: a standard ordinary mail inputting unit accepting predetermined standard mail; and a nonstandard ordinary/parcel mail inputting unit accepting nonstandard ordinary mail and parcel mail other than the standard mail.

The weight and size measuring unit may measure a size and a weight of the mail input in the nonstandard ordinary/parcel mail inputting unit.

Another exemplary embodiment of the present invention provides an unmanned method for accepting mail includes: measuring, when mail is input by a user through a predetermined input unit, a weight of the mail by moving the input mail to a predetermined position and a size of the mail by using a plurality of sensors which is previously provided at the predetermined position; calculating a delivery charge of the mail based on a delivery type selected by the user, and the measured weight and size of the mail; assigning the accepted mail to a predetermined loading space in accordance with the delivery type and the size of the mail when the mail is accepted; and loading the accepted mail in the assigned loading space.

In the measuring, the size of the input mail may be measured by using sensors sensing the input mail among a plurality of sensors disposed at a predetermined interval in an X-axis direction, a Y-axis direction, and a Z-axis direction of the predetermined position.

In the measuring, the size of the input mail may be measured when switches disposed on at least two lateral surfaces of the predetermined position contact the input mail.

The method may further include: acquiring an image of the input mail; recognizing a character included in the acquired image and generating information to be printed on a barcode label based on a character recognition result; and attaching the generated barcode label to the input mail.

In the measuring, it may be determined whether the input mail is standard ordinary mail which is predetermined standard mail and when the input mail is not the standard ordinary mail, the weight and size of the mail may be measured.

According to exemplary embodiments of the present invention, when a client who intends to send mail by using an unmanned mail accepting system installed in a public place or the post office in order to send the mail, the client can save a time for waiting in line at a counter of the post office, it is convenient for the client because the client can send his/her mail in a free time other than business hours of the post office, and the client can be assured of a private life without a temporal limitation.

Further, since a task load for accepting client's mail, which a counter staff of the post office receives can be reduced, a mail processing cost is saved.

Since an accepting result of the unmanned mail accepting system can be, in advance, known through accepted mail quantity information stored in a server when the accepted mail is collected, a conveyance container or a conveyance vehicle required for containing and conveying the mail can be appropriately prepared, thereby saving a time and an effort to collect the mail.

Furthermore, when the system of the present invention is installed in farming and fishing regions where there are not many clients, instead of a manned post office, various expenses for operating the post office can be saved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram for a system according to an exemplary embodiment of the present invention.

FIG. 2 illustrates a configuration of the unmanned mail accepting system illustrated in FIG. 1 according to the exemplary embodiment.

FIG. 3 illustrates a configuration of an exemplary embodiment for a mail inputting unit illustrated in FIG. 2.

FIG. 4 is a conceptual diagram in which input mail is loaded according to the present invention.

FIGS. 5A and 5B are conceptual diagrams for measuring the size of the input mail in the present invention.

FIG. 6 illustrates an operational flowchart of processing standard ordinary mail according to an exemplary embodiment of the present invention.

FIG. 7 illustrates an operational flowchart of processing nonstandard ordinary/parcel mail according to an exemplary embodiment of the present invention.

FIG. 8 illustrates an operational flowchart of loading accepted mail according to the present invention.

FIG. 9 illustrates an operational flowchart of collecting loaded mail according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

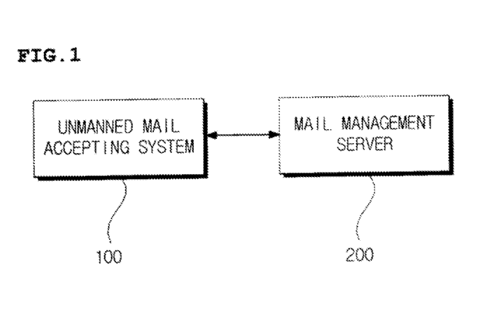

Hereinafter, an unmanned system for accepting mail and a method thereof according to exemplary embodiments of the present invention will be described in detail with reference to FIGS. 1 to 9.

FIG. 1 is a configuration diagram for a system according to an exemplary embodiment of the present invention. As illustrated in FIG. 1, the system includes an unmanned mail accepting system 100 and a mail management server 200.

The unmanned mail accepting system 100 accepts mail, assigns a loading position where the mail is loaded by considering a type, a delivery type, a size, a weight, and the like of the accepted mail, and loads the accepted mail at the assigned loading position.

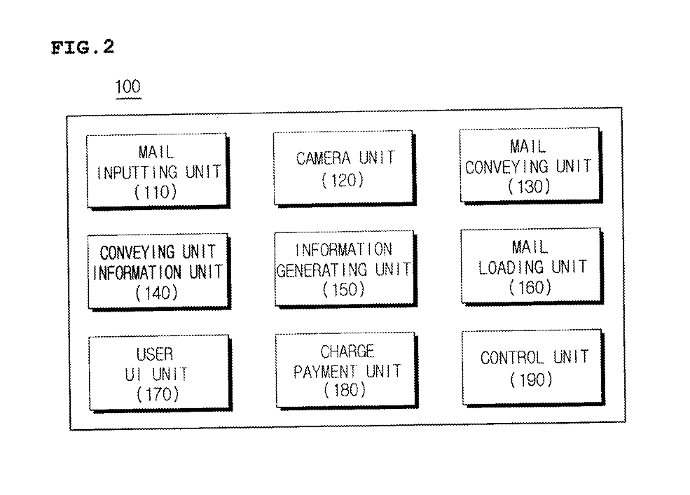

The unmanned mail accepting system 100 separately includes an input unit for accepting ordinary mail and nonstandard ordinary/parcel mail, respectively, that is, an input unit for receiving the mail from a client, acquires a character included in the input mail by a character recognition result through image acquisition, and generates a label including the acquired character recognition result and a delivery charge which is determined depending on, and a weight, a delivery method, a size, and the like of the mail, and the like to attach the generated label to the input mail. The unmanned mail accepting system 100 will be described in detail with reference to FIGS. 2 to 5B.

The mail management server 200 may receive/manage information on mail accepted by a plurality of unmanned mail accepting systems and calculate a size and a quantity of a conveying container for collecting the mail, and a vehicular scale, and the like based on the information on the mail accepted by the unmanned mail accepting system 100.

The mail management server 200 may stores various pieces of information processed by the unmanned mail accepting system 100 and retrieve and provide information requested by an operator or a corresponding system manager according to the circumstances.

The unmanned mail accepting system according to the exemplary embodiment of the present invention may be configured to include only the unmanned mail accepting system 100 illustrated in FIG. 1, but the present invention is not limited thereto and the unmanned mail accepting system may foe configured to include both the unmanned mail accepting system 100 and the mail management server 200.

The system according to the exemplary embodiment of the present invention may interwork with a charge payment network (not illustrated) in order to pay a charge for mail sent by a user.

FIG. 2 illustrates a configuration of the unmanned mail accepting system illustrated in FIG. 1 according to the exemplary embodiment.

Referring to FIG. 2, the unmanned mail accepting system 100 includes a mail inputting unit 110, a camera unit 120, a mail conveying unit 130, a postal charge information unit 140, an information generating unit 150, a mail loading unit 160, a user UI unit 170, a charge payment unit 180, and a control unit 190.

The mail inputting unit 110, as means into which the mail to be delivered is input by the user, may receive (alternatively, accept) the standard ordinary mail and the non standard ordinary/parcel mail.

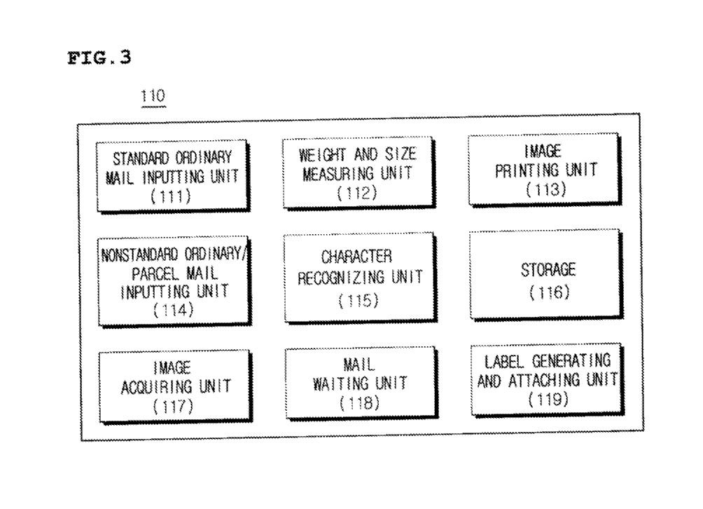

The mail inputting unit 110 includes a standard ordinary mail inputting unit 111, a weight and size measuring unit 112, an image printing unit 113, a nonstandard ordinary/parcel mail inputting unit 114, a character recognizing unit 115, a storage 116, an image acquiring unit 117, a mail waiting unit 118, and a label generating and attaching unit 119, as illustrated in FIG. 3.

The standard ordinary mail inputting unit 111 is configured to receive the standard ordinary mail from the user.

The nonstandard ordinary/parcel mail inputting unit 114 is configured to receive the nonstandard ordinary mail and parcel mail from the user.

The image acquiring unit 117 acquires an image for the standard ordinary mail or the nonstandard ordinary/parcel mail accepted from the user. In this case, the image acquiring unit 117 may acquire an image for the input mail by using an image camera.

The weight and size measuring unit 112 measures a weight and a size (a width, a length, and a height) of the nonstandard ordinary/parcel mail accepted from the user and only a weight with respect to the standard ordinary mail accepted from the user.

The weight, and size measuring unit 112 may measure only the size of the nonstandard ordinary/parcel mail in measuring the size.

In this case, the weight and size measuring unit 112 moves the input mail to a predetermined position and thereafter, may measure the size of the input mail when the input mail contacts a first switch disposed on a first lateral surface and a second switch disposed on a second lateral surface by using the switches disposed on at least two lateral surfaces of the determined position. The weight and size measuring unit 112 may measure the weight of the input mail immediately when the mail is input, but may also measure the weight of the input mail when the size of the mail is measured.

Furthermore, the weight and size measuring unit 112 may measure the size or a volume of the input mail by using a plurality of sensors disposed at a predetermined interval in an X-axis direction, a Y-axis direction, and a Z-axis direction of the determination position.

The character recognizing unit 115 extracts and recognizes a character from the image acquired from the image acquiring unit 117.

In this case, the character recognizing unit 115 may extract and recognize a mailing address from the acquired image.

The mail waiting unit 118 is configured to allow the mail to wait for mail charge payment, and image printing.

The image printing unit 113 prints various pieces of information and various logos on the standard ordinary mail.

Of course, the image printing unit 113 may print various pieces of information and various logos even on the nonstandard ordinary/parcel mail according to the circumstances.

The storage 116 is configured to store the information on the input mail and scores the size, the weight, and the shape information of the mail. In this case, the shape information of the mail may be acquired by processing the image acquired by the image acquiring unit 117 and may also be acquired through the size measurement by the weight and size measuring unit 112.

The label generating and attaching unit 119 generates information to be printed on a barcode label based on the character recognition result included in the acquired image, and attaches the generated barcode label to the input mail.

The label generating and attaching unit 119 generates labels to be attached to the nonstandard ordinary mail and the parcel mail. Of course, according to the circumstances, the label generating and attaching unit 119 may generate a label for the standard ordinary mail.

Referring back to FIG. 2, the camera unit 120 supports a client request to be processed through the image, and may serve to acquire the image of the mail like the image acquiring unit 117 of FIG. 3 according to the circumstances. That is, the camera unit 120 is means for processing the client request by connecting a client and a manager or a customer center that manages and operates the system of the present invention, in addition to the function of acquiring and storing an image for mail in the storage.

The postal charge information unit 140 provides information to calculate the postal charge based on the size and weight of the accepted mail. In this case, the postal charge information unit 140 has information to calculate the postal charge or the delivery charge by considering the size and weight of the mail and as necessary, a delivery type, for example, an ordinary delivery, a registered delivery, and the like.

The information generating unit 150 recognizes an address, and the like from the acquired image and generates information to be printed on the barcode, and the like based on the address, and the like. That is, the information generating unit 150 generates information to be printed on the generated label, as described with reference to FIG. 3. In this case, the information generating unit 150 may generate the information to be printed by using a mailing address database (DB) storing information on a mailing address.

The user UI unit 170 provides a user interface used for the client to operate or process the system from mail accepting up to termination of the mailing accepting.

The charge payment unit 180 pays a charge of the mail accepted in link with an external network, for example, a charge payment network.

In this case, the charge payment unit 180 may provide at least one means which may calculate a charge for the size and weight of the mail and the delivery type by referring to a database storing information on the postal charge and pay the charge by using a cash, T-money, a credit card, and the like.

The mail conveying unit 130, as means for conveying the mail accepted through the mail inputting unit 110 to the mail loading unit 160, may be means that moves horizontally or vertically so that mail accepted in a loading tray of the mail loading unit 160 is loaded.

The mail loading unit 160 is configured to load the mail conveyed from the mail conveying unit 130, that is, the accepted mail of which even payment, is processed, and assigns the loading tray in accordance with the type, size, and shape of the mail, and automatically loads the mail.

In this case, when the mail arrived from the mail conveying unit 130, the mail loading unit 160 may assign the loading tray, which is suitable for the size of the corresponding mail, by receiving shape information or size information of the mail from the control unit 190.

Further, the mail loading unit 160 may include interface means for controlling statistic information such as the quantity of the loaded mail for each type, an acceptance charge, a required container scale and the loaded mail to be collected, means for discharging the mail a plurality of loading trays capable of loading the accepted mail, and means for discharging the mail to collect the loaded mail.

In this case, the mail loading unit 160 may load the accepted mail in a loading tray, which is determined in advance depending on the type, size, and shape of the mail, among the plurality of loading trays.

The control unit 190 serves to control all components of the unmanned mail accepting system according to the present invention.

In order to help appreciation of the system according to the present invention, a process in which the client, that is, a user sends the mail by using the unmanned mail accepting system installed in public places in order to send his/her own mail will be described.

Examples of mail, which may be processed by using the system according to the present invention, includes the standard ordinary mail and the nonstandard ordinary mail, and the parcel mail. In the case of the standard ordinary mail, multiple mails may be accepted at once and in the case of the nonstandard ordinary mail and the parcel mail, mail may be accepted one letter by one letter or one by one.

First, an accepting procedure of the standard ordinary mail will be described. When the standard ordinary menu is selected in the user UI unit 170, the standard ordinary mail inputting unit 111 to accept the standard ordinary mail of the mail inputting unit 110 is opened, when the mail is input, the mail temporarily stops progressing in the image acquiring unit 117 and the weight and size measuring unit 112, and the weight of the mail is measured and stored in the storage 116 simultaneously with acquiring the image by scanning the mail. While the mail continuously progresses and waits in the mail waiting unit 118, the character recognizing unit 115 sequentially calls the mail image stored in the storage 116 to recognise the character. When the aforementioned process is repeatedly performed for the plurality of input mails and a sender performs charge payment by pressing a next button, the system prints an image containing various pieces of information on the mail to complete the accepting.

Next, a processing procedure of the nonstandard mail and the parcel mail will be described. When a nonstandard ordinary/parcel mail menu is selected in the user UI unit 170, the nonstandard ordinary/parcel mail inputting unit 114 is opened. When the mail is input into the input unit, a door of the corresponding input unit is closed and a roller installed on the bottom arranges the mail on a reference surface in width and length directions and temporarily stops. In this case, the image acquiring unit 117 acquires the image of the mail and simultaneously, the weight and size measuring unit 112 measures of the size of three surfaces (width, length, and height) of the mail and the weight of the mail and thus stores the result in the storage 116.

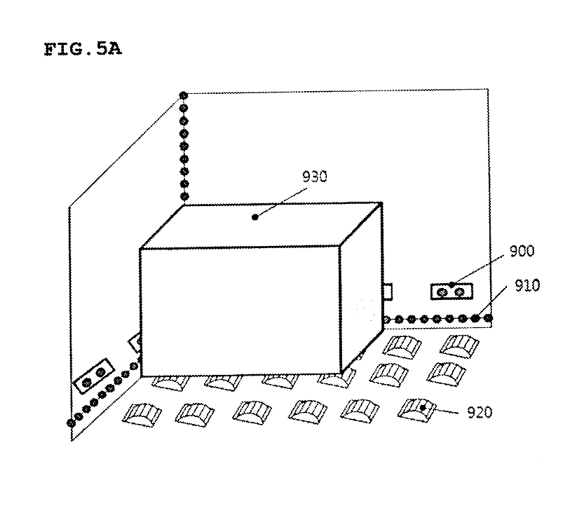

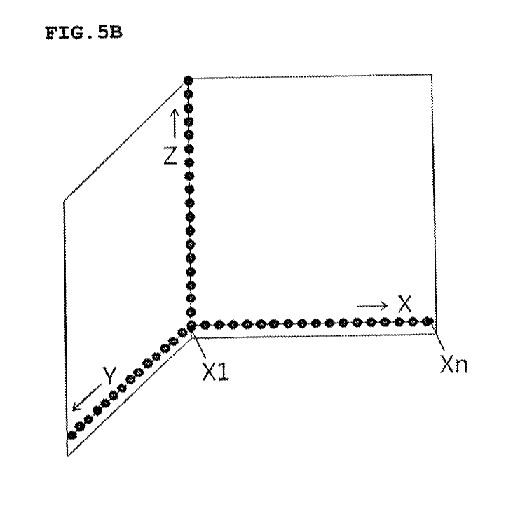

A method of measuring the size (width, length, and height.) of the mail will be described below with reference to FIGS. 5A and 5B. When the sender puts the mail on the input unit of the system, a roller 920 that rotates in a direction of 360° rotates to the left of the input unit to match the mail on a left surface and thereafter, rotates to the inside to match the mail with an inner surface. Switches 900 disposed on respective surfaces serve to stop the mail to match the mail with the respective surfaces. That is, when the mail contacts the switches disposed on at least two lateral surfaces, the mail stops to measure the size of the mail. When the mail stops in close contact with two surfaces, the camera, that is, the image acquiring unit 117 acquires an image on an upper surface of the mail, and the weight and size measuring unit 112 measures the width, length, and height of the mail by signals of respective sensors and measures the weight of the mail.

As a principle of measuring the size of the mail, it is detected whether the sensor is closer, however, the width of the mail is measured on an X axis, when an X1 sensor signal is detected, it is called whether an X2 signal is detected, when the X2 signal, is detected, neighboring signals are consecutively called and when a signal of an n-th sensor is not detected, the size of the mail becomes a length up to an n-1-th sensor, and as a result, the length may be easily calculated. If when the sensors are installed every 10 mm, when a signal of a 10-th sensor from an original point is detected, the length becomes 100 mm. According to the same principle, signals of a Y-axis direction and a Z-axis direction of the mail are detected to calculate the length and height of the mail. The calculated length is compared with a rate table of the postal charge information unit 140 to be used for calculating the postal charge. The mail which matches two surfaces moves back to by the roller in an opposite direction at the position and moves to a position for attaching the label.

Further, the character recognizing unit 115 sequentially calls the mail image stored in the storage 116 to recognise the character and transfers the result to the label generating and attaching unit 119. The label generating and attaching unit 119 generates and prints a label of the information to be attached to the mail, and when the processed mail arrives at a labeler part for attaching the label, the label generating and attaching unit 119 attaches the label to a predetermined position of the mail.

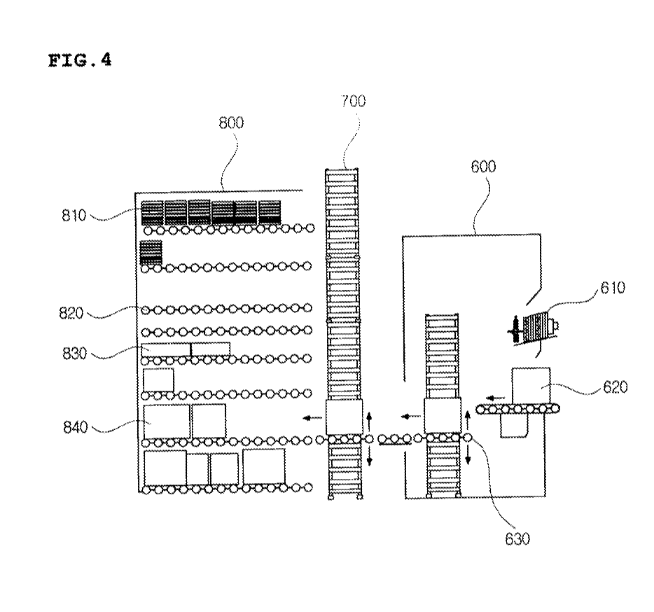

The processed mail as described above is conveyed to a load waiting unit 630 illustrated in FIG. 4, that is, the mail waiting unit 118, and as a result, the mail is loaded in the mail loading unit 160 by the mail conveying unit 130.

Contents printed on the mail or the label will be described below. Only charge information, weight information, a postal code, and a specific image are printed on ordinary mail, while a registration number and a specific image are printed on registered mail in addition to the printing contents of the ordinary mail. The sender may select, the registered mail through a user interface provided by the user UI unit 170.

When the client needs to request a remote support while sending the mail by using the system, the client may request the remote support. When the mail sender presses a remote support button provided by the user UI unit 170, a mail call center or a customer center staff is called and may solve requests of a worker through audio and video.

FIG. 4 is a conceptual diagram in which input mail is loaded according to the present invention. The conceptual diagram will be described below. The system may accept the standard ordinary mail and the nonstandard ordinary/parcel mail through different input holes 610 and 620, respectively.

When the client completes payment, which is a final step, by selecting a menu on a display screen of the system while putting his/her mail on input units 610 and 620 of a system 600, the mail temporarily waits on the load waiting unit 630 of the system and immediately loaded in a specific sorting tray of a loading unit 800 assigned by a mail conveying unit 700. The loading trays of the mail loading unit 800 are configured in various heights and the loading tray is assigned depending on the size of mail to be loaded, in order to increase loading efficiency. That is, accepted mail finds a corresponding loading tray by the mail conveying unit 700 and a roller 820 configured for each loading layer is driven to load the mail. Standard ordinary mail 810 is banded and loaded by the predetermined scale, and nostandard mail 830 and parcel mail 840 are loaded in corresponding loading trays depending on the size of the mail.

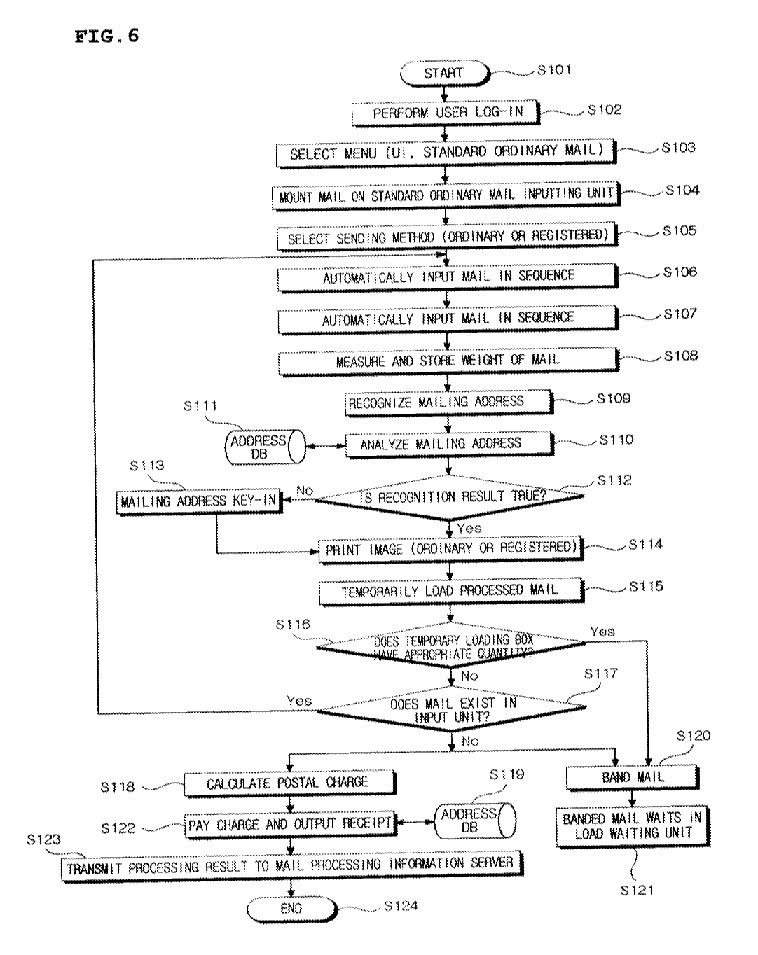

FIG. 6 illustrates an operational flowchart of processing standard ordinary mail according to another exemplary embodiment of the present invention.

Referring to FIG. 6, a mail sending client performs user log-in (inputs a name, an address, and a contact number of a sender) in a user interface provided by a system, selects the standard ordinary mail in a menu and thereafter, mounts mail on a standard ordinary mail inputting unit to be accepted, selects whether the mail is sent as ordinary mail or registered mail, and sequentially inputs the mail (S101 to S106).

While the sequentially input mail progresses along a conveyance line, a mail image is acquired and stored in a storage and just subsequently, while the mail instantly stops in a weight and size measuring unit, the weight of the mail is measured and stored in the storage (S107 and S108).

Of course, in the case of the standard ordinary mail, only the weight thereof is measured, and thus a part for measuring the weight and a part for measuring the size may be separately configured and used according to the circumstances.

The image stored in the storage is sequentially called and a mailing address is extracted and recognized by a character recognizing unit or a character recognizer and a character recognition result is analyzed by referring to an address DB which is stored in advance (S109 to S112).

As the mail recognition result, while mail failed to be recognized is discharged to a discharge hole to be reinput or is not discharged, a sender inputs the mailing address to thereby normally process the mail, and in the case of the normally (S) recognised mail, an ordinary mail image or a registered mail image is printed at a predetermined position of the mail in accordance with the method selected by the client (S113, and S114).

The mail printed with the image waits in a temporary storage provided in the system and when the mail has a predetermined scale, the mails are banded to wait in a load waiting unit (S115, S116, S120, and S121). When the mails are not accumulated in a temporary loading box as many as a predetermined quantity, the system determines whether the mail is present in the mail inputting unit and when the mail is present, the mail is continuously input in the device and the aforementioned process is repeated (S117).

On the contrary, as a determination result of step S117, when there is no mail to be input into the mail inputting unit and the mail that is waiting in the temporary storage is one or more, the mails are also banded to wait in the load waiting unit and a postal charge is calculated by referring to a postal charge information DB to allow a mail sender to pay a charge (S118 and S119).

When the sender pays the charge, a receipt is output and all processing results are sent to and stored in a mail management server and the system stops after a predetermined time passes (S122 to S124).

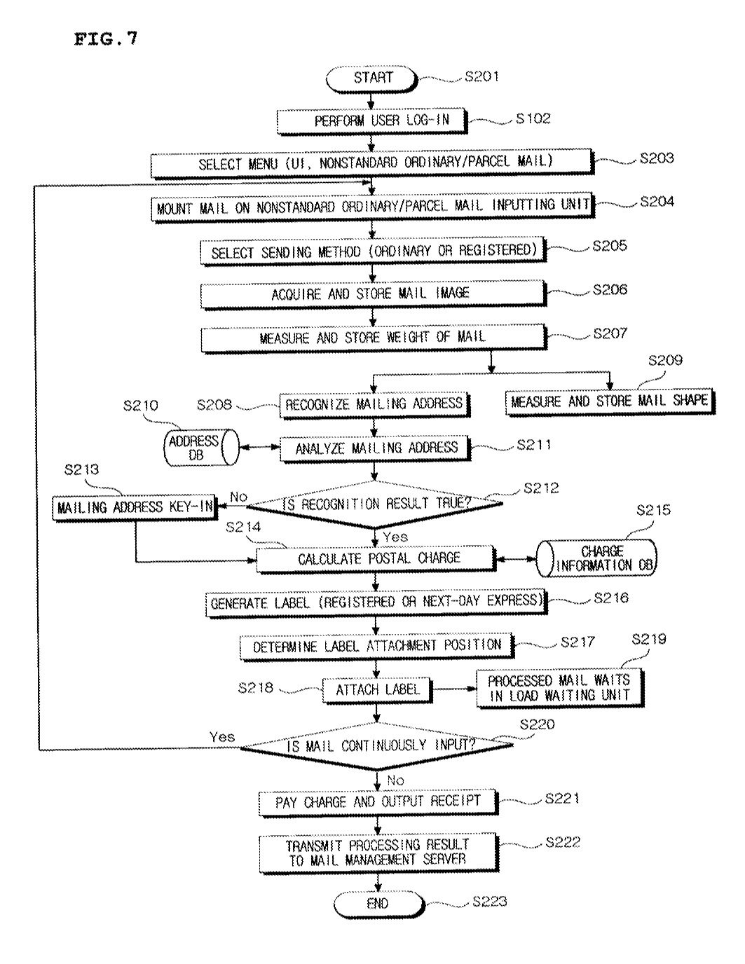

FIG. 7 illustrates an operational flowchart of processing nonstandard ordinary/parcel mail according to an exemplary embodiment of the present invention.

Referring to FIG. 7, a client who intends to send mail inputs a name, an address, a contact, number, and the like of a sender (performs user log-in) in a user interface of a system, selects the nonstandard ordinary/parcel mail in a menu and thereafter, inputs the mail in a nonstandard ordinary/parcel mail inputting unit one by one, selects whether to send the mail as registration mail or next-day express mail, and inputs the mail by pressing a next button (S201 to S205).

When the mail is input, a door of the input hole is closed and as described with reference to FIGS. 5A and 5B, an image of the mail is acquired and a result thereof is stored in the storage and just subsequently, a weight is measured and stored in the storage (S206 and S207).

A character recognizer extracts a mailing address by calling the image stored in the storage, performs recognition by extracting a character string, and analyzes the address by referring to an address DB which is stored in advance (S208, S210, and S211). Simultaneously, a mail shape measuring module, that is, a weight and size measuring unit calculates and stores a shape (a width, a length, and a height) of the mail (S209).

The processes of steps S207 and S209 are sequentially performed, but the present invention is not limited thereto and it should be understood that both the size (alternatively, the shape) and the weight of the mail may be simultaneously measured.

When a character recognition result by the character recognition is abnormal (F), a manual address input is performed (key-in) and when the character recognition result, is normal (S), the postal charge is calculated by referring to a charge information DB of the mail and a label to be attached to the surface of the mail is generated and it is determined at which location of the surface of the mail the label will be attached and thereafter, the label is attached to the surface of the mail and the mail attached with the label waits in a mail load waiting unit (S212 to S219).

When there is no mail to be sent longer, the client pays the charge by selecting a charge payment button in the user interface and receives the receipt, and a processing result is transmitted to and stored in a mail management server (S220 to S223).

As a determination result in step S220, the client selects a mail input button in the user interface in order to continuously input the mail, and as a result, a process of supplying the mail to the nonstandard ordinary/parcel mail inputting unit is performed and thus, the aforementioned process is repeated.

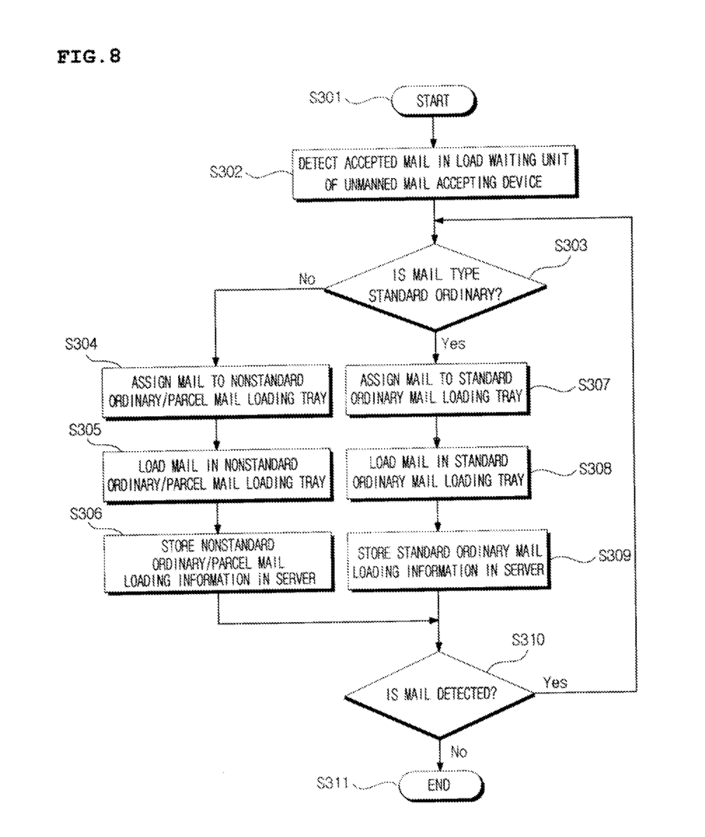

FIG. 8 illustrates an operational flowchart of loading accepted mail according to the present invention.

Referring to FIG. 8, the mail accepted through the system of the present invention is transferred to a mail conveying unit by a load waiting unit and the mail is loaded in a loading tray of a specific loading layer of a loading unit depending on a size of the corresponding mail calculated when the mail is accepted by the system. The process will be described with reference to FIG. 4.

As illustrated in FIG. 4, when the mail is detected by the load waiting unit 630 of the system, it is determined whether the type of the mail is the standard ordinary mail based on accepting information of the accepted mail and when the mail is the standard ordinary mail, the standard ordinary mail loading tray is assigned and the mail is loaded in the assigned loading tray and thereafter, the information is stored in a server (S302, S303, and S307 to S309).

Similarly, when the type of the mail is not the standard ordinary mail, that is, when the type of the mail is the nonstandard ordinary/parcel mail, the nonstandard ordinary/parcel mail loading tray is assigned and the mail is loaded in the assigned loading tray, and loading information is stored in the server (S304 to S306).

In this case, in step S304, in the case of the nonstandard ordinary mail, the loading tray for the nonstandard ordinary mail may be assigned and in the case of the parcel mail, the loading tray for the parcel mail may be assigned.

Thereafter, it is determined whether the mail is detected in the waiting unit 620 and when new mail exists, the process is fed back to step S303 and when the new mail is not detected for a predetermined time, the system stops (S310 and S311). That is, when the accepted mail exists in the waiting unit 620 of the system, the process of determining whether the type of the mail is the standard ordinary mail is performed again and when no mail is detected in the waiting unit 620 for a predetermined time, the system stops.

A manager may view a status of the mail loaded in the loading unit of the system through the mail management server, the information is used when the loaded mail is collected, and the mail loaded in the loading unit is collected and sent to the post office or a center. In order to collect the mail, a conveying container or a scale of a vehicle is appropriately determined in advance. The information may be known through the server.

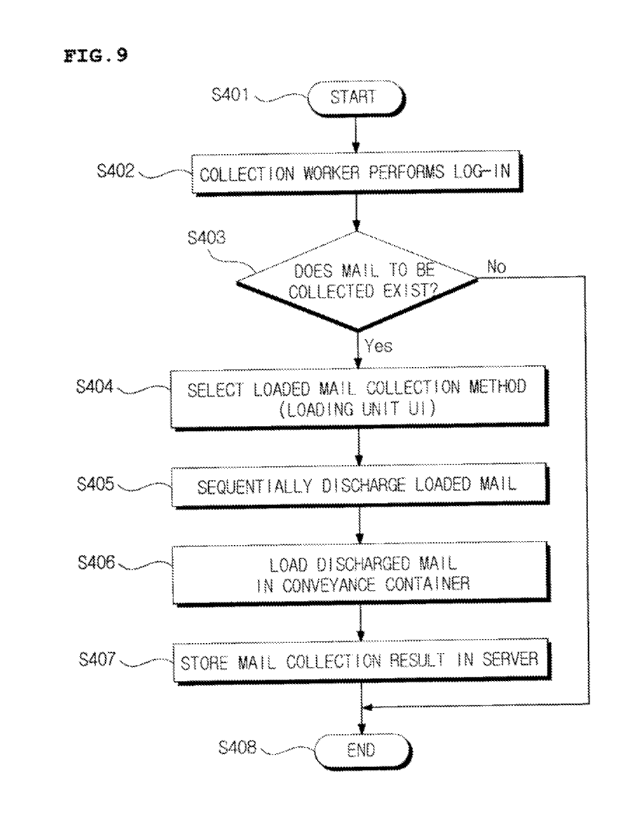

FIG. 9 illustrates an operational flowchart of collecting loaded mail according to the present, invention.

Referring to FIG. 9, a collection worker logs in the system and determines whether the loaded mail exists in the loading unit of the system (S401 to S403).

As a determination result in step S403, when mail to be collected exists, the worker selects a collection method in a loading unit UI menu and the mail is sequentially discharged through the selected collection method (S404 and S405). In the mail collection method, the mail may be collected in a reverse order regardless of the type of the accepted mail or according to the mail type.

When the mail is discharged, the discharged mail is loaded in a brought conveyance container and collection information regarding the collected mail is stored in the mail management server (S406 and S407).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present, construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An unmanned system for accepting mail, comprising:
a weight and size measuring unit measuring, when mail is input by a user through a predetermined input unit, a weight of the mail by moving the input mail to a predetermined position and a size of the mail by using a plurality of sensors which is previously provided at the predetermined position;
a delivery charge calculating unit calculating a delivery charge of the mail based on a delivery type selected by the user, and the measured weight and size of the mail; and
a mail loading- unit assigning the accepted mail to a predetermined loading space in accordance with the delivery type and the size of the mail when the mail is accepted and loading the accepted mail in the assigned loading space.

2. The system of claim 1, wherein:
the weight and size measuring unit
includes a plurality of sensors disposed at a predetermined interval in an X-axis direction, a Y-axis direction, and a Z-axis direction of the predetermined position, and
measures the size of the input mail by using sensors sensing the input mail among the plurality of sensors.

3. The system of claim 1, wherein:
the weight and size measuring unit
includes switches disposed on at least two lateral surfaces of the predetermined position, and
measures the size of the input mail when a first switch disposed on a first lateral surface and a second switch disposed on a second lateral surface contact the input mail.

4. The system of claim 1, further comprising:
a mail management server calculating and managing the sizes and the number of conveyance containers, and the scale of a vehicle that collect the loaded mail, based on information on the mail loaded in the mail loading unit.

5. The system of claim 1, further comprising:
an image acquiring unit acquiring an image of the input mail; and
a label generating and attaching unit recognizing a character included in the acquired image, generating information to be printed on a barcode label based on a character recognition result, and attaching the generated barcode label to the input mail.

6. The system of claim 1, further comprising:
a standard ordinary mail inputting unit accepting predetermined standard mail; and
a nonstandard ordinary/parcel mail inputting unit accepting nonstandard ordinary mail and parcel mail other than the standard mail.

7. The system of claim 6, wherein:
the weight and size measuring unit
measures a size and a weight of the mail input in the nonstandard ordinary/parcel mail inputting unit.

8. An unmanned method for accepting mail, comprising:
measuring, when mail is input by a user through a predetermined input unit, a weight of the mail by moving the input mail to a predetermined position and a size of the mail by using a plurality of sensors which is previously provided at the predetermined position;
calculating a delivery charge of the mail based on a delivery type selected by the user, and the measured weight and size of the mail;
assigning the accepted mail to a predetermined loading space in accordance with the delivery type and the size of the mail when the mail is accepted; and
loading the accepted mail in the assigned loading space.

9. The method of claim 8, wherein:
in the measuring,
the size of the input mail is measured by using sensors sensing the input mail among a plurality of sensors disposed at a predetermined interval in an X-axis direction, a Y-axis direction, and a Z-axis direction of the predetermined position.

10. The method of claim 8, wherein:
in the measuring,
the size of the input mail is measured when switches disposed on at least two lateral surfaces of the predetermined position contact the input mail.

11. The method of claim 8, further comprising:
acquiring an image of the input mail;
recognizing a character included in the acquired
image and generating information to be printed on a barcode label based on a character recognition result; and
attaching the generated barcode label to the input mail.

12. The method of claim 8, wherein:
in the measuring,
it is determined whether the input mail is standard ordinary mail which is predetermined standard mail and when the input mail is not the standard ordinary mail, the weight and size of the mail is measured.
